(19) United States
(12) Patent Application Publication
(10) Pub. No.: US 2024/0127609 A1
(43) Pub. Date: Apr. 18, 2024

(54) DRIVER MONITORING DEVICE AND DRIVER MONITORING METHOD

(71) Applicant: Toyota Jidosha Kabushiki Kaisha, Toyota-shi (JP)

(72) Inventors: Kazuya Okamoto, Toyota-shi (JP); Yuta Hiraiwa, Miyoshi-shi (JP)

(73) Assignee: Toyota Jidosha Kabushiki Kaisha, Toyota-shi (JP)

(21) Appl. No.: 18/481,817

(22) Filed: Oct. 5, 2023

(30) Foreign Application Priority Data
Oct. 12, 2022 (JP) 2022-163831

(51) Int. Cl. G06V 20/59; B60W 30/09; B60W 40/08

(52) U.S. Cl. CPC G06V 20/597; B60W 30/09; B60W 40/08; B60W 2040/0827; B60W 2420/42; B60W 2540/221; B60W 2540/225; B60W 2540/229

(57) ABSTRACT

To effectively determining whether the driver is in the specific state according to the use of the driving assistance device, provided is a driver monitoring device which is applied to a vehicle having a driving assistance device configured to execute a predetermined driving assistance control for assisting the driving of a driver. The driver monitoring device comprising a driver state acquisition unit configured to acquire a state of the driver; and a driver state determination unit configured to determine that the driver is in a specific state when the state of the driver acquired by the driver state acquisition unit satisfies a predetermined condition. The driver state determination unit is configured to relaxes the predetermined condition when the driving assistance device is executing the driving assistance control, as compared with a case where the driving assistance device is not executing the driving assistance control.

### BACKGROUND OF THE INVENTION

### 1. Field of the Invention

The present disclosure relates to a driver monitoring device and a driver monitoring method.

### 2. Description of the Related Art

Japanese Patent Application Laid-Open (kokai) No. 2002-025000 discloses a device that detects a direction of a line of sight of a driver by a driver monitor device, and determines a state of the driver based on the detected result. In addition, the device executes both the information display control and the vehicle control at an appropriate timing based on the determined result of the state of the driver.

When the driver using a driving assistant device such as an Adaptive Cruise Control (ACC) or a Lane Trace Asist (LTA), the driver's attention tends to be deteriorated. In such a case, it is preferable from the viewpoint of safety to further advance the start timing of the vehicle control and the information display control. However, if the state of the driver is always determined based on the same condition regardless of whether or not the driver uses the driving assistance device, there is a problem that the detecting timing of a specific state of the driver cannot be advanced even if the driver's attention is actually deteriorated due to the use of the driving assistance device.

### SUMMARY OF THE INVENTION

The present disclosure has been devised in order to solve the above-mentioned problem. That is, one object of the present disclosure is to effectively determining whether the driver is in the specific state according to the use of the driving assistance device.

A device according to at least one embodiment of the present disclosure is a driver monitoring device which is applied to a vehicle having a driving assistance device configured to execute a predetermined driving assistance control for assisting the driving of a driver. The driver monitoring device comprising a driver state acquisition unit configured to acquire a state of the driver; and a driver state determination unit configured to determine that the driver is in a specific state when the state of the driver acquired by the driver state acquisition unit satisfies a predetermined condition. The driver state determination unit is configured to relaxes the predetermined condition when the driving assistance device is executing the driving assistance control, as compared with a case where the driving assistance device is not executing the driving assistance control.

According to the above aspect, the driver monitoring device relaxes the condition for determining whether the driver is in the specific state when the driving assistance system is executing the driving assist. This makes it possible to detect that the driver is in the specific state at an early stage when the driver's attention is deteriorated due to the use of the driving assistance system.

### BRIEF DESCRIPTION OF THE DRAWINGS

FIG. 1 is a schematic diagram showing a hardware configuration of a vehicle according to the present embodiment.

FIG. 2 is a schematic diagram showing a software configuration of a control device to the present embodiment.

FIG. 3 is a flow chart for explaining a routine of a determination condition relaxation process.

FIG. 4 is a flow chart for explaining a routine of a driver abnormality determination process.

FIG. 5 is a flow chart for explaining a routine of a collision avoidance control.

### DESCRIPTION OF THE EMBODIMENTS

Description is now given of a driver monitoring device and a driver monitoring method according to at least one embodiment of the present disclosure with reference to the drawings.

### Hardware Configuration

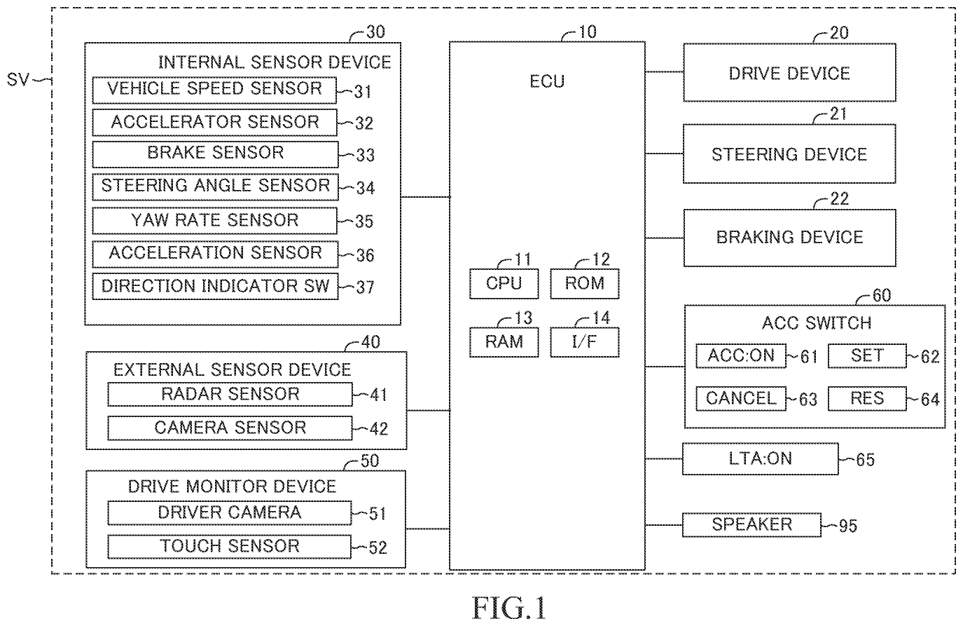

FIG. 1 is a schematic diagram of a hardware configuration of a vehicle SV to which the driver monitoring device according to the present embodiment is applied. Hereinafter, the vehicle SV may be referred to as an own vehicle when it is required to distinguish it from other vehicles.

The vehicle SV has an ECU (Electronic Control Unit) 10. The ECU 10 includes a CPU (Central Processing Unit) 11, ROM (Read Only Memory) 12, RAM (Random Access Memory) 13, an interface device 14, and the like. The CPU 11 executes various programs stored in the ROM 12. The ROM 12 is a non-volatile memory that stores data and the like required for the CPU 11 to execute various programs. The RAM 13 is a volatile memory to provide a working region that is deployed when various programs are executed by the CPU 11. The interface device 14 is a communication device for communicating with an external device.

The ECU 10 is a central device which executes driving assistance control of the vehicle SV, such as ACC, LTA and a collision avoidance control (Pre-Crash Safety Control: PCS control). Driving assistance control is a concept which encompasses automatic driving control. Therefore, a drive device 20, a steering device 21, a braking device 22, an internal sensor device 30, an external sensor device 40, a driver monitor device 50, an ACC switch 60, a LTA activation switch 65, a speaker 95, and the like are communicably connected to the ECU 10.

The drive device 20 generates a driving force to be transmitted to driving wheels of the vehicle SV. As the drive device 20, for example, an engine and a motor are given. In the device according to the at least one embodiment, the vehicle SV may be any one of a hybrid electric vehicle (HEV), a plug-in hybrid electric vehicle (PHEV), a fuel cell electric vehicle (FCEV), a battery electric vehicle (BEV), and an engine vehicle. The steering device 21 applies steering forces to steerable wheels of the vehicle SV. The braking device 22 applies a braking force to the wheels of the vehicle SV.

The internal sensor device 30 is sensors which acquire states of the vehicle SV. Specifically, the internal sensor device 30 includes a vehicle speed sensor 31, an accelerator sensor 32, a brake sensor 33, a steering angle sensor 34, a yaw rate sensor 35, an acceleration sensor 36, a direction indicator switch 37, and the like.

The vehicle speed sensor 31 detects a travel speed (vehicle speed V) of the vehicle SV. The accelerator sensor 32 detects an operation amount of an accelerator pedal (not shown) by the driver. The brake sensor 33 detects an operation amount of a brake pedal (not shown) by the driver. The steering angle sensor 34 detects a rotational angle of a steering wheel or a steering shaft (not shown) of the vehicle SV, that is, a steering angle. The yaw rate sensor 35 detects a yaw rate of the vehicle SV. The acceleration sensor 36 detects an acceleration of the vehicle SV. The direction indicator switch 37 detects an operation of a direction indicator lever (not shown) by the driver. The internal sensor device 30 transmits the condition of the vehicle SV detected by the sensors 31 to 37 to the ECU 10 at a predetermined cycle.

The external sensor device 40 is sensors which acquire object information on objects around the vehicle SV. Specifically, the periphery recognition device 40 includes a radar sensor 41, a camera sensor 42, and the like. As the object information, there are given, for example, a peripheral vehicle, a traffic light, a white line of a road, a traffic sign, a fallen object, and the like.

The radar sensor 41 is provided in, for example, a front portion of the vehicle SV, and detects a target existing in a region located on the front side of the vehicle SV. The radar sensor 41 includes a millimeter wave radar or Lidar. The millimeter wave radar radiates a radio wave (millimeter wave) in a millimeter wave band, and receives the millimeter wave (reflected wave) reflected by a target existing within a radiation range. The millimeter wave radar acquires a relative distance between the vehicle SV and the target, a relative speed between the vehicle SV and the target, and the like based on a phase difference between the transmitted millimeter wave and the received reflected wave, an attenuation level of the reflected wave, a time from the transmission of the millimeter wave to the reception of the reflected wave, and the like. The Lidar sequentially scans laser light in a pulse form having a shorter wavelength than that of the millimeter wave in a plurality of directions, and receives reflected light reflected by a target, to thereby acquire a shape of the target detected in front of the vehicle SV, the relative distance between the vehicle SV and the target, the relative speed between the vehicle SV and the target, and the like.

The camera sensor 42 is, for example, a stereo camera or a monocular camera, and a digital camera including an image pickup element such as a CMOS sensor or a CCD sensor can be used as the camera sensor 42. The camera sensor 42 is arranged in, for example, a top portion of a front windshield glass of the vehicle SV. The camera sensor 42 captures a region in front of the vehicle SV, and processes captured image data, to thereby obtain the object information in front of the vehicle SV. The object information is information indicating a type of the target detected in front of the vehicle SV, the relative distance between the vehicle SV and the target, the relative speed between the vehicle SV and the target, and the like. It is only required to recognize the type of the target through, for example, machine learning such as pattern matching.

The external sensor device 40 repeatedly transmit the acquired object information to the ECU 10 each time a predetermined time elapses. The ECU 10 composes the relative relationship between the vehicle SV and the target acquired by the radar sensor 41 and the relative relationship between the vehicle SV and the target acquired by the camera sensor 42, to thereby determine a relative relationship between the vehicle SV and the target. It is not always required for the external sensor device 40 to include both of the radar sensor 41 and the camera sensor 42, and may include, for example, only the radar sensor 41 or only the camera sensor 42.

The driver monitor device 50 is a device for acquiring the state of the driver of the vehicle SV, and includes a driver camera 51, a steering touch sensor (hereinafter, referred to as a touch sensor) 52, and the like. The driver camera 51 mainly captures an image of the driver's face, and detects the direction of the line of sight, the eye opening state, and the like from the captured face image. The touch sensor 52 detects whether or not the driver is gripping the steering wheel. The driver monitor device 50 transmits the state of the driver (hereinafter, driver state information) acquired based on the detection results of the driver camera 51 and the touch sensor 52 to ECU10 at a predetermined cycle. Note that the driver monitor device 50 does not need to include both the driver camera 51 and the touch sensor 52, and may include only the driver camera 51. Further, the driver monitor device 50 may include other sensors capable of acquiring the state of the driver, such as a physiological measurement device that measures the heart rate, the pulse rate, and the like of the driver, and a seating sensor that detects the seating state of the driver.

The ACC switch 60 is a switch group provided in a neighborhood of a driver's seat (for example, a steering wheel, a steering column, or the like), and operated by the driver. The ACC switch 60 includes an ACC activation switch 61, a setting switch 62, a cancel switch 63, a resume switch 64, and the like. The ACC activation switch 61 is a switch for the driver to select to activate or stop the ACC. The setting switch 62 is a switch to freely set or change a target vehicle speed and a target inter-vehicle distance (or a target inter-vehicle time) of the ACC. The cancel switch 63 is a switch for temporarily canceling the ACC being executed. The resume switch 64 is a switch for resuming the ACC.

The LTA activation switch 65 is provided in the neighborhood of the driver's seat (for example, a steering wheel, or the like). The LTA activation switch 65 is ON/OFF switch for selecting by the driver whether the activating or terminating the LTA.

The speaker 95 is, for example, a speaker of an audio system or a speaker of a navigation system, and outputs a warning sound or the like in response to a command from ECU 10.

### Software Configuration

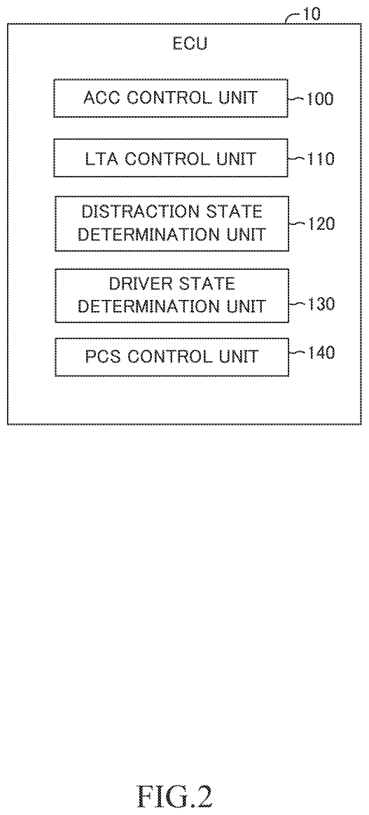

FIG. 2 is a schematic diagram showing a software configuration of the ECU 10 to the present embodiment. As shown in FIG. 2, the ECU 10 includes an ACC control unit 100, a LTA control unit 110, a distraction state determination unit 120, a driver state determination unit 130, a PCS control unit 140, and the like as a part of functional elements. Those functional elements 100 to 140 are described as being included in the ECU 10 which is integrated hardware, but any part thereof may be provided to an ECU independent of the ECU 10. Moreover, a part of the functional elements 100 to 140 of the ECU 10 may be provided to an external information processing device of a facility (for example, a managing center) which can communicate to and from the vehicle SV.

The ACC control unit 100 executes the ACC based on the target vehicle speed and the target inter-vehicle distance (or the target inter-vehicle time). The ACC itself is well known. Thus, a brief description is now given of the ACC. The ACC includes two types of control, namely, the constant-speed travel control and the follow-up travel control. The constant-speed travel control is control of causing the vehicle SV to travel at a constant speed in accordance with the target vehicle speed without requiring the accelerator operation of the driver. The follow-up travel control is control of causing the vehicle SV to travel such that the vehicle SV follows a preceding vehicle while maintaining the inter-vehicle distance to the preceding vehicle at the target inter-vehicle distance. The preceding vehicle is a vehicle traveling in front of the vehicle SV.

When the ACC activation switch 61 is turned ON, the ACC control unit 100 determines whether or not there is a preceding vehicle to be followed on the basis of the object information transmitted from the external sensor device 40. When determining that the preceding vehicles do not exist, the ACC control unit 100 executes constant speed travel control. In this case, the ACC control unit 100 controls the driving of the driving device 20 so that the vehicle speed V coincides with the target vehicle speed, and also controls the operation of the braking device 22 as needed. On the other hand, when it is determined that the preceding vehicles exist, the ACC control unit 100 executes the follow-up travel control. In this case, the ACC control unit 100 controls the driving of the driving device 20 so that the inter-vehicle distance between the vehicle SV and the preceding vehicle coincides with the target inter-vehicle distance, and also controls the operation of the braking device 22 as needed.

The LTA control unit 110 executes the LTA for automatically changing the steering angle (steered wheel turning angle) so that the position of the vehicle SV is maintained in the vicinity of the target traveling lane. The LTA itself is well known. Thus, a brief description is now given of the LTA. When the LTA activation switch 65 is turned ON, the LTA control unit 110 sets the target traveling line of the vehicle SV on the basis of either one or both of the white line recognized by the external sensor device 40 or the traveling trajectory of the following target vehicle (that is, the preceding vehicle) by ACC. The traveling trajectory of the following target vehicle may be acquired based on the object information transmitted from the external sensor device 40. The LTA control unit 110 changes the steering angle of the vehicle SV by controlling the operation of the steering device 21 so that the lateral position of the vehicle SV (that is, the position of the vehicle SV in the vehicle-width direction with respect to the road) is maintained near the target traveling line in the traveling lane.

The LTA control unit 110 changes the setting of the target traveling line in accordance with the recognition-state of the white line and the presence or absence of the following target vehicle. For example, when the left and right white lines are recognized to be far away, the LTA control unit 110 sets the target travel line based on the center line of the travel lane. In other words, the LTA control unit 110 sets the target traveling line based on only the white line. On the other hand, when the following target vehicle is present and the left and right white lines are not recognized or only the left and right white lines are recognized in the vicinity, the LTA control unit 110 sets the target travel line based on the preceding vehicle traveling trajectory alone or both the preceding vehicle traveling trajectory and the center line of the travel lane. When the following target vehicles do not exist and the left and right white lines cannot be recognized far away, the LTA control unit 110 cancels executing the LTA.

The distraction state determination unit 120 determines whether the driver is in a distraction state in which the driver is not paying attention to the surroundings when the driver is using the ACC and/or the LTA. When the driver uses the ACC or the LTA continuously for a predetermined period or longer, the driver tends to be distracted due to monotonous driving. The distraction state determination unit 120 determines that the driver is in the distraction state when the touch sensor 52 does not detect continuous gripping of the steering wheel by the driver, when the steering angle sensor 34 does not detect a steering operation of a predetermined amount or more by the driver, or when the driver does not detect another driving operation by the driver, during a period from when at least one of the ACC activation switch 61 and the LTA activation switch 65 is turned ON until a predetermined period of time elapses. Examples of other driving operations include depression of an accelerator pedal, temporary cancel of the ACC by depression of a brake pedal or ON of the cancel switch 63, resumption of the ACC by ON of the resume switch 64, and operation of the turn signal lever. When the distraction state determination unit 120 determines that the driver is in the distraction state, it transmits the determination result to the driver state determination unit 130.

The driver state determination unit 130 determines, based on the driver state information transmitted from the driver monitor device 50, whether the driver is in an abnormal state (specified state) in which it is difficult for the driver to continuously perform the driving operation of the vehicle SV due to continuous inattentiveness, sleepiness, seizure, or the like. The driver state determination unit 130 acquires the direction of the line of sight, the eye-opening state, the grip of the steering wheel, and the like of the driver based on the driver state information transmitted from the driver monitor device 50. The driver state determination unit 130 determines that the driver is in an abnormal state when at least one of a first state in which the direction of the line of sight of the driver is out of a predetermined range including the front of the vehicle SV, a second state in which the eyes of the driver are closed, or a third state in which the driver is not holding the steering wheel continues for a predetermined first threshold-time T1 or longer.

Here, when the driver uses driving assistance such as the ACC or the LTA, the driver's attention tends to decrease, and therefore, it is desired to shorten the first threshold-time T1, that is, to detect an anomaly of the driver at an early stage by relaxing the determination condition. However, if the determination conditions are constantly relaxed due to the use of the ACC or the LTA, erroneous determination may occur frequently. Thus, the driver state determination unit 130 relaxations the determination condition when the distraction state determination unit 120 determines that the driver is in the distraction state during the operation of the ACC and/or the LTA. Specifically, the driver condition determination unit 130 performs abnormality determination of the driver based on the first relaxation threshold time T1′ obtained by subtracting the predetermined quantity Td1 from the first threshold time T1 (T1′=T1−Td1). This allows early detection of driver anomalies when the driver uses the ACC or the LTA and is distracted. The predetermined quantity Td1 may be a fixed value or may be a variable value. For example, the predetermined quantity Td1 may be increased as the vehicle speed V is increased.

The PCS control unit 140 executes PCS control for avoiding collision between own vehicle SV and the front object or reducing damage to the collision. Specifically, the PCS control unit 140 obtains the coordinate information of the object existing in front of the vehicle SV based on the object information transmitted from the external sensor device 40. Further, the PCS control unit 140 calculates the turning radius of the vehicle SV based on the detection results of the vehicle speed sensor 31, the steering angle sensor 34, and the yaw rate sensor 35, and calculates the trajectory of the vehicle SV based on the turning radius. The PCS control unit 140 determines whether the moving object and the stationary object in front of the vehicle SV are obstacles that may collide with the vehicle SV. When the object is a moving object, the PCS control unit 140 calculates the trajectory of the moving object based on the coordinate information of the moving object, and when the trajectory of the moving object and the trajectory of the vehicle SV intersect each other, determines the moving object as an obstacle. When the object is a stationary object, the PCS control unit 140 determines that the stationary object is an obstacle when the trajectory of the vehicle SV intersects the present position of the stationary object.

When the PCS control unit 140 determines that the object is an obstacle, the PCS control unit 140 calculates a predicted collision time (Time To Collision: TTC) until the vehicle SV collides with the obstacle based on the distance L from the vehicle SV to the obstacle and the relative velocity Vr of the vehicle SV with respect to the obstacle. TTC is an index indicating a possibility that the vehicle SV collides with an obstacle. TTC can be determined by dividing the distance L from own vehicle SV to the obstacle by the relative velocity Vr (TTC=L/Vr).

The PCS control unit 140 determines that the vehicle SV is highly likely to collide with the obstacle when the state in which TTC is equal to or smaller than the predetermined collision determination threshold Tv continues for a predetermined second threshold T2 or longer. When determining that there is a high possibility of collision, the PCS control unit 140 executes an alarm by the speaker 95 and starts a deceleration control. The deceleration control is a control for decelerating the vehicle SV such that the deceleration of the vehicle SV coincides with a preset target deceleration by controlling the operation of the braking device 22. As described above, when the condition in which TTC is equal to or less than the collision determination threshold value Tv continues for the second threshold value period T2 or more is set as the execution condition of the deceleration control and the alarm, it is possible to effectively suppress the unnecessary operation of the deceleration control and the alarm.

Here, when the driver is in an abnormal state, it is desired to advance the operation of the deceleration control and the alarm by relaxing the execution conditions of the deceleration control and the alarm. When the driver state determination unit 130 determines that the driver is in the abnormal state, the PCS control unit 140 determines whether to execute the deceleration control or the alarm based on the second relaxation threshold time T2′ obtained by subtracting the predetermined quantity Td2 from the second threshold time T2(T2′=T2−Td2). Accordingly, when the abnormality is detected in the driver, the operation of the deceleration control and the alarm can be advanced, and thus the safety can be improved. The predetermined quantity Td2 may be a fixed value or may be a variable value. For example, the predetermined quantity Td2 may be increased as the vehicle speed V is increased.

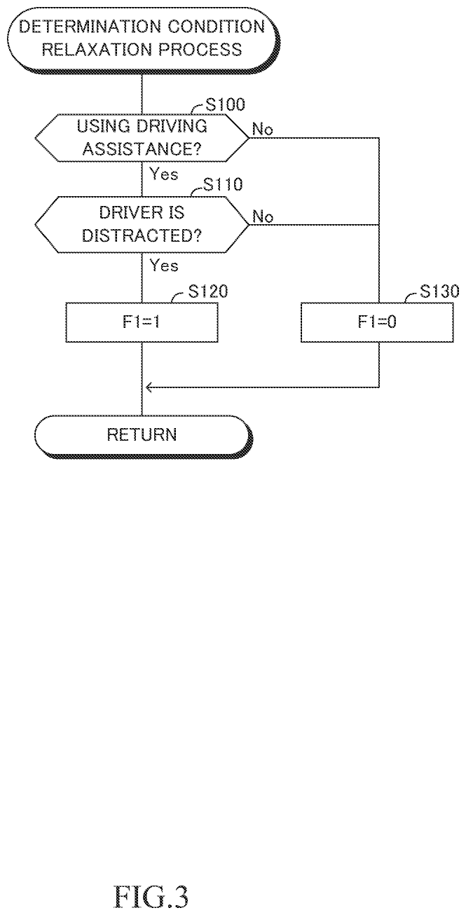

FIG. 3 is the flow chart for explaining a routine of a determination condition relaxation process by the CPU 11 of the ECU 10. This routine is started, for example, when the vehicle SV runs.

In step S100, the ECU 10 determines whether or not the driver is using driving assistance, that is, whether or not at least one of the ACC activation switch 61 and the LTA activation switch 65 is turned ON. If the drivers are using driving assistance (Yes), the ECU 10 advances the process to step S110. On the other hand, when the driver does not use the driving assistance (No), the ECU 10 advances the process to step S130.

In step S110, the ECU 10 determines whether the driver is distracted. Specifically, when the touch sensor 52 does not detect continuous gripping of the steering wheel by the driver, or when the steering angle sensor 34 does not detect a steering operation of the predetermined amount or more by the driver, or when other state operation by the driver is not detected, the ECU 10 determines that the driver is distracted after at least one of the ACC activation switch 61 and the LTA activation switch 65 is turned ON until the predetermined time elapses. If the driver is distracted (Yes), the ECU 10 advances the process to step S120. On the other hand, if the driver is not distracted (No), the ECU 10 advances the process to step S130.

In step S120, the ECU 10 sets the determination-condition relaxation flag F1 for subtracting the predetermined quantity Td1 from the first threshold-time T1 to ON (F1=1), and returns this routine. On the other hand, if the process proceeds from step S100 and S110 to step S130, the ECU 10 sets the determination condition-relaxation flag F1 to OFF (F1=0) and returns this routine.

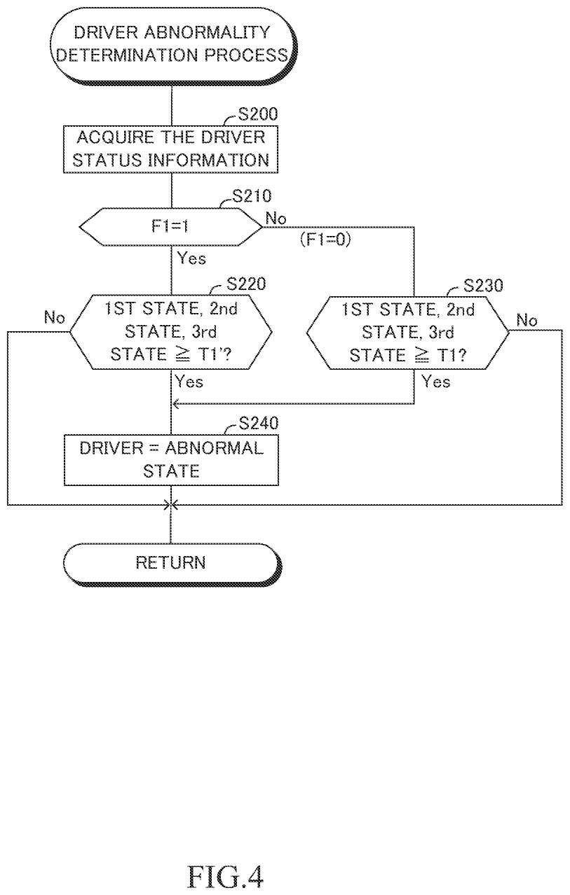

FIG. 4 is the flow chart for explaining a routine of a driver abnormality determination process by the CPU 11 of the ECU10. This routine is started, for example, when the vehicle SV travels, and is executed in parallel with the routine of the determination condition relaxation process shown in FIG. 3.

In step S200, the ECU 10 acquires the driver status information from the driver monitoring device 50. Next, in the step S210, the ECU10 determines whether the determination condition relaxation flag F1 is set to ON (F1=1) by the above described determination condition relaxation process. When the determination condition relaxation flag F1 is set to “ON” (Yes), the ECU 10 advances the process to step S220.

In step S220, the ECU 10 determines whether the drivers are in the abnormal condition based on the first relaxation threshold time T1′ which is obtained by subtracting the predetermined quantity Td1 from the first threshold time T1 (T1′=T1−Td1). Specifically, it is determined whether at least one of the first state in which the direction of the line of sight of the driver is out of the predetermined range including the front of the vehicle SV, the second state in which the eyes of the driver are closed, or the third state in which the driver is not holding the steering wheel continues for the first relaxation threshold time T1′ or more. If the determination is No, the ECU 10 returns to this routine. On the other hand, if the determination result is affirmative (Yes), the ECU 10 advances the process to step S240 to determine that the driver is in the abnormal state, and returns to this routine.

When the determination of step S210 is negative (No), that is, when the determination condition relaxation flag F1 is off (F1=0), the ECU 10 advances the process to step S230. That is, it is determined whether at least one of the first state, the second state, and the third state described above continues for the first threshold time T1 or longer. If the determination is No, the ECU 10 returns to this routine. On the other hand, if the determination result is affirmative (Yes), the ECU 10 proceeds to step S240 to determine that the driver is in the abnormal state, and returns to this routine.

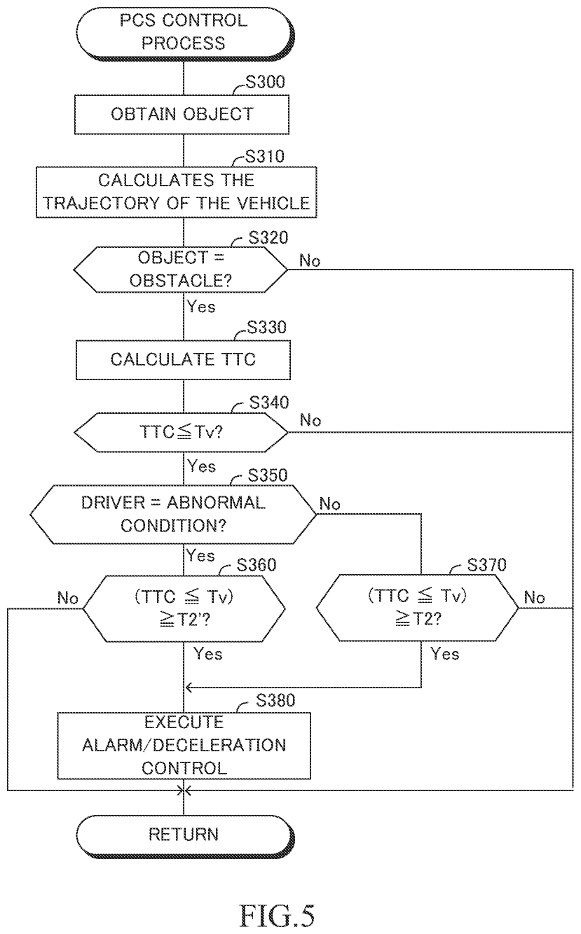

FIG. 5 is the flow chart for explaining a routine of the PCS control process by the CUP 11 of the ECU 10. This routine is started when the vehicle SV travels, and is executed in parallel with the routines of the respective processes shown in FIG. 3 and FIG. 4.

In step S300, the ECU 10 obtains the coordinate information of the object existing in the front area of the vehicle SV based on object information transmitted from the external sensor device 40. Next, in the step S310, the ECU 10 calculates the trajectory of the vehicle SV based on the detection results of the vehicle speed sensor 31, the steering angle sensor 34, and the yaw rate sensor 35. Note that the processes of step S300 and step S310 are out of order and may be performed simultaneously.

In step S320, the ECU 10 determines whether the object in front of the vehicle SV is the obstacle that may collide with the vehicle SV. If the object is the moving object, the ECU 10 determines that the moving object is the obstacle when the trajectory of the moving object intersects the trajectory of the vehicle SV. In addition, the ECU 10 determines that the stationary object is the obstacle when the trajectory of the vehicle SV intersects the present position of the stationary object. When the ECU 10 determines that the object in front of the vehicle SV is the obstacle (Yes), the ECU 10 advances the process to step S330. On the other hand, if the ECU 10 determines that the object in front of the vehicle SV is not the obstacle (No), the ECU 10 returns this routine.

In step S330, the ECU 10 calculates the TTC by dividing the distance L from the vehicle SV to the obstacle by the relative speed Vr (TTC=L/vr). Then, in step S340, the ECU 10 determines whether the TTC is less than or equal to the collision determination thresholds Tv. If the TTC is less than or equal to the collision-determination-threshold Tv (Yes), the ECU 10 advances the process to Step S350. On the other hand, if the TTC is greater than the collision-determination-threshold Tv (No), the ECU 10 returns this routine.

In step S350, the ECU 10 determines whether the driver is determined to be in the abnormal condition by the above described driver abnormality determination process. If it is determined that the driver is in the abnormal condition (Yes), the ECU 10 advances the process to Step S360.

In step S360, the ECU 10 determines whether or not the vehicle SV is likely to collide with the obstacle based on the second relaxation threshold time T2′ obtained by subtracting the predetermined quantity Td2 from the second threshold time T1 (T2′=T2−Td2). Specifically, it is determined whether the condition in which the TTC is equal to or less than the collision determination threshold Tv continues for the second relaxation threshold T2′ or longer. If the determination is No, the ECU 10 returns this routine. On the other hand, if the determination is affirmative (Yes), the ECU 10 advances the process to step S380 to execute the alarm/deceleration control, and returns this routine.

When the determination of step S350 is negative (No), that is, when the drivers are not determined to be abnormal, the ECU 10 advances the process to Step S370. In step S370, the ECU 10 determines, based on the second threshold time T2, whether the vehicle SV is likely to collide with the obstacle. Specifically, it is determined whether the state in which the TTC is equal to or smaller than the collision determination threshold Tv continues for the second threshold time T2 or longer. If the determination is No, the ECU 10 returns this routine. On the other hand, if the determination is affirmative (Yes), the ECU 10 advances the process to Step S380 to execute the alarm/deceleration control, and returns this routine.

According to the at least one embodiment described in detail above, when the distraction state determination unit 120 determines that the driver is in the distraction state during the operation of the ACC or the LTA, the driver state determination unit 130 reduces the determination condition by shortening the first threshold-time T1 for determining the abnormality of the driver. Accordingly, when the driver actually becomes distracted due to the use of the ACC or the LTA, the anomaly of the driver can be detected at an early stage. In addition, when the driver state determination unit 130 determines that the driver is in the abnormal state, the PCS control unit 140 reduces the execution condition by reducing the second threshold time T2 for determining execution of the deceleration control or the alarm. Accordingly, when an abnormality is detected in the driver, the deceleration control by the PCS control and the operation of the alarm can be advanced, and thus the safety can be reliably improved.

In the above, the driver monitoring device and the driver monitoring method according to the at least one embodiment have been described, but the present disclosure is not limited to the above-mentioned at least one embodiment, and various modifications are possible within the range not departing from the object of the present disclosure.

For example, in the above described embodiment, the PCS control is exemplified by the deceleration control, but the steering avoidance control may be performed to automatically control the steering angle of steered wheel of the vehicle so as to avoid a collision with an obstacle. Further, the driving assist control is not limited to the ACC and the LTA, and may be another driving assist control can be applied.

1. A driver monitoring device which is applied to a vehicle having a driving assistance device configured to execute a predetermined driving assistance control for assisting the driving of a driver, the driver monitoring device comprising:
a driver state acquisition unit configured to acquire a state of the driver; and
a driver state determination unit configured to determine that the driver is in a specific state when the state of the driver acquired by the driver state acquisition unit satisfies a predetermined condition,
wherein the driver state determination unit is configured to relaxes the predetermined condition when the driving assistance device is executing the driving assistance control, as compared with a case where the driving assistance device is not executing the driving assistance control.

2. The driver monitoring device according to claim 1,
wherein the driver state acquisition unit is configured to acquire at least a direction of a line of sight of a driver as the state of the driver, and
wherein the driver state determination unit is configured to determine that the predetermined condition is satisfied, when the direction of the line of sight of the driver acquired by the driver state acquisition unit is continuously in a predetermined state for a predetermined first threshold time or more, and
wherein the driver state determination unit is configured to reduce the predetermined first threshold time when the driving assistance device is executing the driving assistance control, as compared with the case where the driving assistance device is not executing the driving assistance control.

3. The driver monitoring device according to claim 1,
wherein the specific state includes at least a continuous inattentiveness, a sleepiness or a seizure of the driver.

4. The driver monitoring device according to claim 1,
wherein the driving assistance device is configured to execute a collision avoidance control for avoiding a collision between the vehicle and an obstacle or reducing the damage of the collision when the obstacle in front of the vehicle satisfies a predetermined collision condition continues for a predetermined second threshold time or more, and
wherein the driving assistance device is configured to reduce the predetermined second threshold time when the driver state determination unit determines that the driver is in the specific state.

5. A driver monitoring method which is applied to a vehicle having a driving assistance device configured to execute a predetermined driving assistance control for assisting the driving of a driver, the driver monitoring method comprising:
a driver state acquisition process for acquiring a state of the driver; and
a driver state determination process for determining that the driver is in a specific state when the state of the driver acquired by the driver state acquisition process satisfies a predetermined condition,
wherein the driver state determination process is configured relaxing the predetermined condition when the driving assistance device is executing the driving assistance control, as compared with a case where the driving assistance device is not executing the driving assistance control.

6. The driver monitoring device according to claim 2,
wherein the specific state includes at least a continuous inattentiveness, a sleepiness or a seizure of the driver.

7. The driver monitoring device according to claim 2,
wherein the driving assistance device is configured to execute a collision avoidance control for avoiding a collision between the vehicle and an obstacle or reducing the damage of the collision when the obstacle in front of the vehicle satisfies a predetermined collision condition continues for a predetermined second threshold time or more, and
wherein the driving assistance device is configured to reduce the predetermined second threshold time when the driver state determination unit determines that the driver is in the specific state.
